(19) United States
(12) Patent Application Publication
(10) Pub. No.: US 2025/0115372 A1
(43) Pub. Date: Apr. 10, 2025

(54) PORTABLE DEICING APPARATUS AND ASSOCIATED METHODS

(71) Applicant: POLAR AIRCRAFT DEICER INC., Saint-Basile (CA)

(72) Inventors: Jimmy RACINE, Saint-Basile (CA); Mathieu DAGNAULT, Saint-Basile (CA); Aurèle LABBÉ, Saint-Basile (CA)

(73) Assignee: POLAR AIRCRAFT DEICER INC., (omitted)

(21) Appl. No.: 18/628,149

(22) Filed: Apr. 5, 2024

Related U.S. Application Data
(60) Provisional application No. 63/587,802, filed on Oct. 4, 2023.

(51) Int. Cl. B64F 5/23

(52) U.S. Cl. CPC B64F 5/23

(57) ABSTRACT

The present disclosure concerns a portable deicing apparatus for spraying deicing fluid, comprising: a deicing fluid reservoir defining a component housing connected to the deicing fluid reservoir; a fluid dispensing device located inside the component housing and in fluid communication with the deicing fluid reservoir to propel the deicing fluid outwardly; a heating system having a heating unit in a heat exchange with deicing fluid in the deicing fluid reservoir; an energy supply assembly operatively connected to the heating unit; and a controller located inside the component housing and operatively connected to at least the fluid dispensing device and the heating system. The deicing fluid reservoir, the component housing, the fluid dispensing device, the heating system, the energy supply assembly, and the controller are displaceable as a single assembly. A method for transferring the portable deicing apparatus and a method for preliminarily warming deicing fluid are also provided.

### CROSS-REFERENCE TO RELATED APPLICATIONS

This application claims priority under 35 USC § 119(e) of U.S. provisional patent application 63/587,802 filed on Oct. 4, 2023, the specification of which is hereby incorporated by reference.

### TECHNICAL FIELD

The present disclosure generally relates to deicing systems, and more particularly to portable deicing systems to provide a deicing treatment to items such as aircraft components. It also relates to a method for transferring a portable deicing apparatus between two carriers and a method for warming deicing fluid preliminarily to a deicing operation.

### BACKGROUND

When experiencing frost and snow conditions, an aircraft may undergo a preflight procedure to free surfaces and components thereof of snow and ice deposits to limit aerodynamic and/or mechanical interference during take-off and flight. For this purpose, airports and aerodromes that experience freezing conditions will use aircraft deicing fluid, which is generally heated and sprayed onto the plane where needed to remove surface frost, ice or frozen contaminants and prevent the formation thereof for a time. To apply deicing fluid, airports and airfields use specialized vehicles and equipment for spraying deicing fluid on airplanes as efficiently as possible. During this logistically demanding procedure, time and coordination are crucial in an environment with high operational costs and, as many frequent flyers would have experienced, subject to delays.

Various systems exist to apply a deicing agent onto an aircraft. In recent years, developments in the industry have focused on larger scale equipment in view of reducing operational costs. It may be appealing to provide airfields with larger machines with the added benefit of dispensing deicing fluid at a greater volume and flow. Contemporary systems generally provide dedicated vehicles with elongated articulated arms mounted with powerful pumps to dispense fluid from a high vantage point to cover a larger area of the aircraft at any given time. However, in some respects, such cumbersome and costly machines have lost in flexibility, especially when applying deicing fluid on the lower components of the aircraft, such as the underwings, engine intake, landing gears and propellers, if applicable. This is particularly true for bigger airfields, CDF (central de-icing facilities), gate deicing and/or aircraft where a single deicing vehicle may be available to “deice” an aircraft. For example, after having applied deicing fluid onto the upper surfaces of an aircraft from a vehicle equipped with an elevated articulated arm, an operator of said articulated arm may have to pause the deicing operation only to dismount his/her vehicle to then spray deicing fluid manually onto the lower components with an auxiliary line while the rest of the equipment remains idle. Additionally, aircraft deicing equipment requires precision to avoid inadvertently wasting spraying fluid.

Finally, there is a shift in the aviation industry's regulatory framework to transition to electric equipment in an effort to lower carbon emissions and reduce the carbon footprint of the industry. Therefore, there is still a need for an improved deicing apparatus for aircraft.

### BRIEF SUMMARY

According to an aspect, there is provided a portable deicing apparatus for spraying deicing fluid. The portable deicing apparatus comprises a deicing fluid reservoir, a component housing, a fluid dispensing device, a heating system, an energy supply assembly and a controller. The deicing fluid reservoir defines a deicing fluid containing chamber and having an upper surface. The component housing is connected to the deicing fluid reservoir. The fluid dispensing device is at least partially located inside the component housing and is in fluid communication with the deicing fluid containing chamber to propel deicing fluid contained in the deicing fluid containing chamber outwardly. The heating system has a heating unit in a heat exchange relationship with the deicing fluid contained in the deicing fluid containing chamber. The energy supply assembly is operatively connected to the heating unit. The controller is at least partially located inside the component housing and is operatively connected to at least the fluid dispensing device and the heating system. The deicing fluid reservoir, the component housing, the fluid dispensing device, the heating system, the energy supply assembly, and the controller are displaceable as a single assembly.

In an embodiment, the portable deicing apparatus further comprises mechanical fasteners mounted to at least one of the deicing fluid reservoir and the component housing to detachably secure the portable deicing assembly to a carrier assembly of a ground transport vehicle.

In an embodiment, the mechanical fasteners are mounted to the deicing fluid reservoir and the mechanical fasteners include hooks provided on lateral surfaces of the deicing fluid reservoir.

In an embodiment, the portable deicing apparatus further comprises a battery operatively connectable to an internal battery of the ground transport vehicle.

In an embodiment, the fluid dispensing device comprises an electric pump operatively connected to the battery configured to supply energy to the electric pump.

In an embodiment, the portable deicing apparatus further comprises a safety valve in fluid communication with the deicing fluid containing chamber. The safety valve includes an overflow duct extending outwardly from the upper surface of the deicing fluid reservoir and a covering flap pivotally mounted to an upper end portion of the overflow duct.

In an embodiment, the deicing fluid reservoir further comprises a deicing fluid outlet and a deicing fluid inlet providing access to the deicing fluid containing chamber. The portable deicing apparatus further comprises a deicing fluid discharge line in fluid communication with the fluid dispensing device to propel and apply deicing fluid contained in the deicing fluid containing chamber. The deicing fluid discharge line is engageable with the deicing fluid inlet to collect and return a remaining portion of the deicing fluid into the deicing fluid containing chamber.

In an embodiment, the heating unit comprises a heat exchanger extending at least partially inside the deicing fluid containing chamber.

In an embodiment, the heating system comprises a carburant burner in the heat exchange relationship with the heat exchanger. The energy supply assembly comprises a carburant reservoir mounted to at least one of the deicing fluid reservoir and the component housing. The carburant reservoir defines a carburant containing chamber in fluid communication with the carburant burner.

In an embodiment, the energy supply assembly comprises a battery operatively connected to the heat exchanger.

In an embodiment, heating system further comprises an external recirculation system at least partially contained in the component housing and in fluid communication with the deicing fluid containing chamber. The heating system also includes a power supply connector electrically connectable to an external power source.

In an embodiment, the heating further comprising an elongated frame mounted to the upper surface of the deicing fluid reservoir and extending upwardly therefrom, the elongated frame comprising a ladder and a basket mounted to the ladder and located at an upper end thereof.

According to another aspect, there is provided a portable deicing apparatus, as detailed above, for spraying deicing fluid in combination with a ground transport vehicle having a carrier assembly. The carrier assembly of the ground transport vehicle comprises anchors engageable by the mechanical fasteners of the portable deicing apparatus to detachably secure the portable deicing apparatus to the carrier assembly.

In an embodiment, the portable deicing apparatus further comprises a base frame engaged with at least the deicing fluid reservoir, providing mechanical support thereto and having a planar lower surface. The carrier assembly has a supporting surface engageable with at least the planar lower surface of the base frame.

In an embodiment, the component housing has a planar lower surface, and the planar lower surface of the base frame and the planar lower surface of the component housing are arranged to form a contiguous planar surface engageable with the supporting surface of the carrier assembly.

In an embodiment, the carrier assembly is one of a trailer having a bed and a pickup bed.

In an embodiment, the carrier assembly has a supporting surface. Each one of the deicing fluid reservoir and the component housing have a lower surface and the lower surfaces are planar for at least one of the lower surface of the deicing fluid reservoir and the lower surface of the component housing to contact the supporting surface of the carrier assembly.

According to still another aspect, there is provided a method for transferring a portable deicing apparatus, as detailed above, from a first carrier assembly to a second carrier assembly. The method comprises detaching the portable deicing apparatus from the first carrier assembly; displacing the portable deicing apparatus to the second carrier assembly as a single assembly; and detachably securing the portable deicing apparatus to the second carrier assembly.

According to yet another aspect, there is provided a method for preliminarily warming deicing fluid of a portable deicing apparatus for a deicing operation. The method comprises providing a portable deicing apparatus, as detailed above; preliminarily to a deicing operation in which deicing fluid is sprayed outwardly of the portable deicing apparatus, connecting the power supply connector of the external recirculation system to the external power source to continuously recirculate the deicing fluid between the deicing fluid containing chamber and the external recirculation system in a closed circulation loop to provide a heat exchange therebetween and warm the deicing fluid to an operating temperature; and disconnecting the power supply connector of the external recirculation system from the external power source before the deicing operation.

In an embodiment, the method for preliminarily warming deicing fluid of a portable deicing apparatus for a deicing operation further comprises displacing the portable deicing apparatus to a carrier assembly of a ground transport vehicle as a single assembly and detachably securing the portable deicing apparatus to same.

### BRIEF DESCRIPTION OF THE DRAWINGS

FIG. 1 is a front perspective view of a portable deicing apparatus, including a deicing fluid reservoir, a component housing, a fluid dispensing device actuated via an electric motor, a heating system including an external recirculation system, an energy supply assembly and a controller, in accordance with an implementation;

FIG. 2 is a rear elevation view of the portable deicing apparatus shown in FIG. 1;

FIG. 3 is a left side elevation view of the portable deicing apparatus shown in FIG. 1;

FIG. 4 is a right side elevation view of the portable deicing apparatus shown in FIG. 1;

FIG. 5 is a top plan view of the portable deicing apparatus shown in FIG. 1;

FIG. 6 is a bottom plan view of the portable deicing apparatus shown in FIG. 1;

FIG. 7 is a perspective view of a portable deicing apparatus, in accordance with another implementation, wherein the heating system is exempt of an external recirculation system, and the dispensing device is actuated via a carburant-fed motor;

FIG. 8 is a perspective view, partially sectioned, of the portable deicing apparatus shown in FIG. 7, detachably secured to a carrier assembly of a ground transport vehicle, in accordance with an implementation, wherein a liftgate of the carrier assembly is in an open configuration;

FIG. 9 is a perspective of the portable deicing apparatus mounted to the carrier assembly of the ground transport vehicle shown in FIG. 8, wherein the liftgate is configured in a closed (transport) configuration; and

FIG. 10 is a rear perspective view of a portable deicing apparatus, in accordance with another implementation, detachably secured to the carrier assembly of the ground transport vehicle, and wherein an elongated frame including a ladder and a basket is mounted to an upper surface of the deicing fluid reservoir.

### DETAILED DESCRIPTION

As will be explained below in relation to various implementations, the present disclosure describes systems and devices for facilitating the application of deicing fluid, such as and without being limitative, onto components of an aircraft, and particularly lower components thereof, such as the lower surface of the wings (e.g., portions of the flaps, ailerons and slats), engine intake, landing gears and propellers, if applicable. According to one aspect, the present disclosure relates to a portable deicing apparatus used in combination with a carrier assembly of a ground vehicle by detachably securing the apparatus to the carrier assembly. According to another aspect, the deicing apparatus is portable as a single assembly (i.e., a single unit) to ease its relocation from one carrier assembly to the next carrier assembly or platform.

It will be noted that the term “portable”, as may be used herein, is to be understood as meaning able to be easily carried or displaced compared to an industry standard in the art of deicing equipment, at least in part because of its lighter and smaller build. The characteristics that make the deicing apparatus “portable” are described in more details below.

The present disclosure describes a portable deicing apparatus that integrates electric components aimed at reducing the consumption of fossil fuel-based carburants.

According to yet another aspect, the portable deicing apparatus can be equipped with an elongated frame from which an operator may dispense deicing fluid onto upper components of light aircraft or small airplanes, such as the Beechcraft™ 1900, the King Air™ 350, the Learjet™ 60, the Pilatus™ PC-12, and the Cessna™ Citation.

The present disclosure also provides a method for transferring a portable deicing apparatus from a carrier assembly to another. Additionally, a method for preliminarily warming a deicing fluid to a desired operating temperature outside of a use period of the portable deicing apparatus using an external recirculation system is provided.

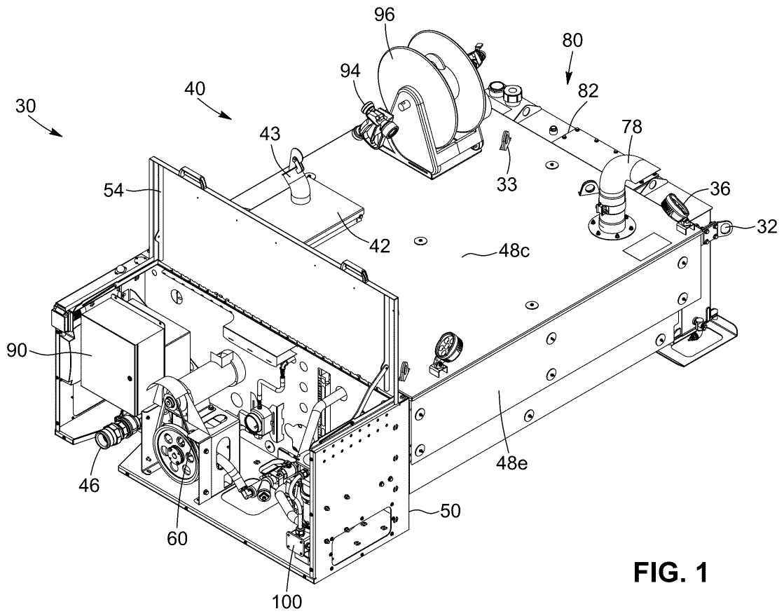

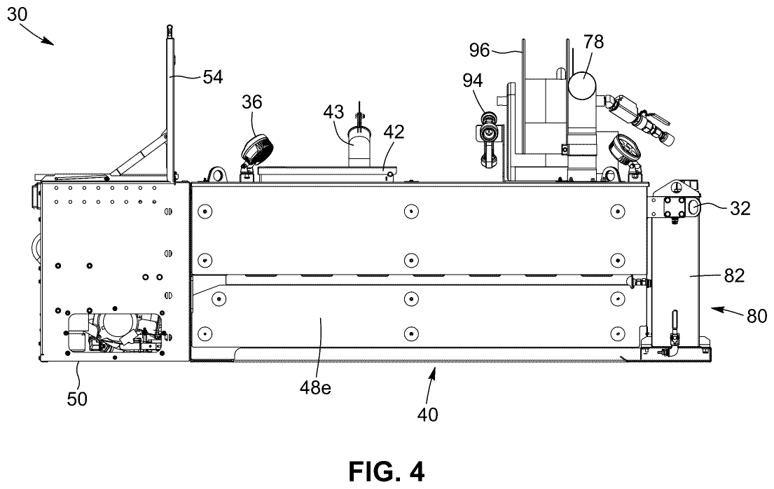

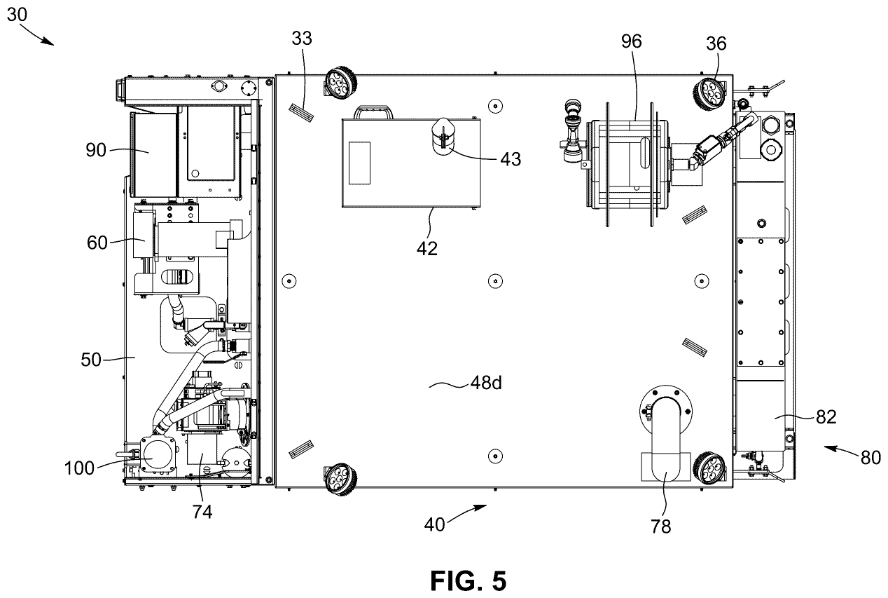

Referring to the drawings, and more particularly with reference to FIGS. 1 to 10, there is provided a portable deicing apparatus 30, 130, 230 for applying deicing fluid such as and without being limitative, onto components of an aircraft. The portable deicing apparatus comprises a deicing fluid reservoir 40, a component housing 50 connected to the reservoir 40, a fluid dispensing device 60 in fluid communication with the reservoir 40, a heating system 70, an energy supply assembly 80 and a controller 90. It will be noted that, for the purpose of this disclosure, the deicing apparatus 30, 130, 230 purports to contain, heat, and apply a deicing fluid. For instance, and without being limitative, the deicing fluid can be a Type I deicing fluid. It should be noted that the portable deicing apparatus 30, 130, 230 described herein does not intend to be limited to contain and apply Type I fluid.

It will be noted that the expression “components of an aircraft”, as may be used herein, is to be understood as any component on the outside of the aircraft that is generally subjected to a deicing procedure, and may include the fuselage, the wings, the stabilizers, the propellers, and the landing gears.

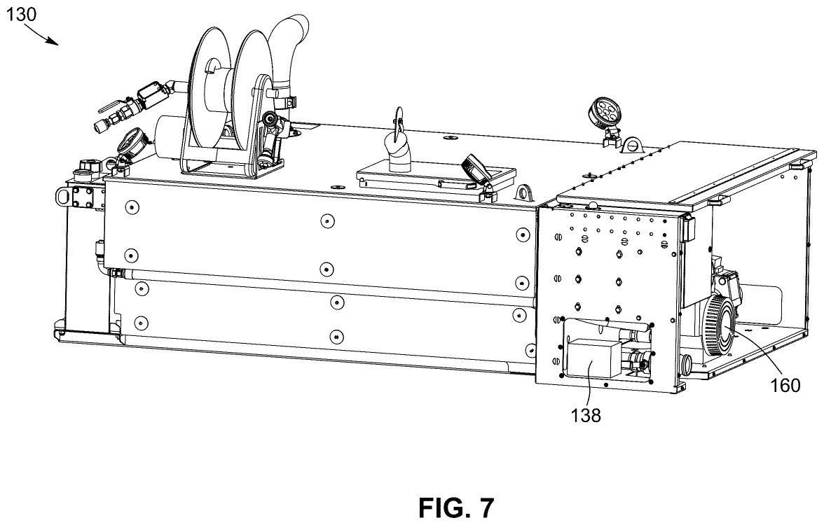

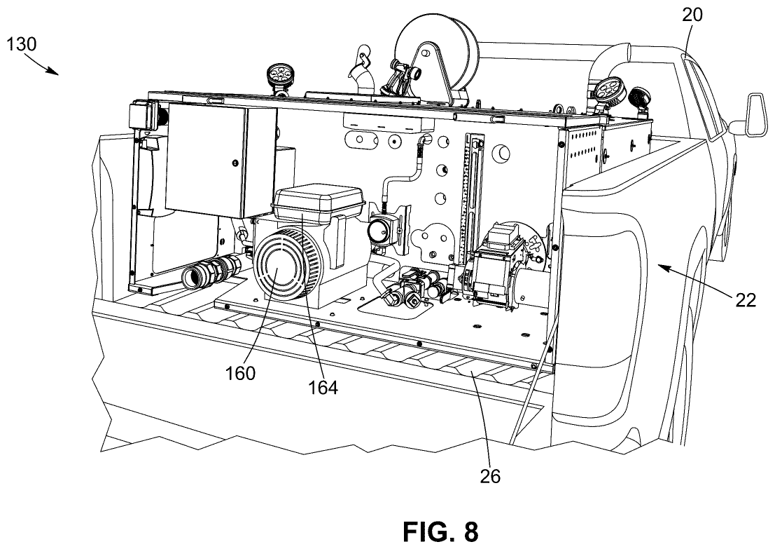

The portable deicing apparatus 30, 130, 230 is autonomous in that it can operate without external power supply (with the exception of the external recirculation system, as explained further below), deicing fluid supply, or external heating supply when mounted to a carrier assembly 22, such as a trailer bed or the bed of a pickup, and optionally connected to a ground transport vehicle. For instance, in the exemplary implementations of FIGS. 8 to 10, the portable deicing apparatus 130, 230 is shown mounted to the carrier assembly 22 of the transport vehicle, and more specifically to the bed of a pickup truck. As mentioned, the deicing apparatus 30, 130, 230 can be mounted to a trailer bed of a trailer (not shown), and the trailer can be coupled to a respective transport vehicle for towing, for instance. It should be noted that the implementation of the portable deicing apparatus 30 shown in FIGS. 1 to 6 can also be secured to the carrier assembly 22 in the same manner as the implementation of the portable deicing apparatus 130, 230 illustrated in FIGS. 8 to 10. Moreover, the portable deicing apparatus 30, 130, 230 can be oriented such that the front side of the deicing fluid reservoir 40 faces a front end of the carrier assembly 22 (i.e., faces a normal forward direction of travel of the carrier assembly 22), and such that the rear side of the deicing fluid reservoir 40 faces a rear end of the carrier assembly 22 (i.e., faces the tailgate of the pickup truck if a pickup truck is used). According to one implementation of the portable deicing apparatus 30, 130, 230 specifically shaped and sized for the bed of a pickup truck, a right lateral surface 48f and a left lateral surface 48e of the deicing fluid reservoir 40 can have an inverted “staircase” shape to contour protrusions of the bed adapted for the rear wheels of the pickup truck, as better shown in FIGS. 1 and 7.

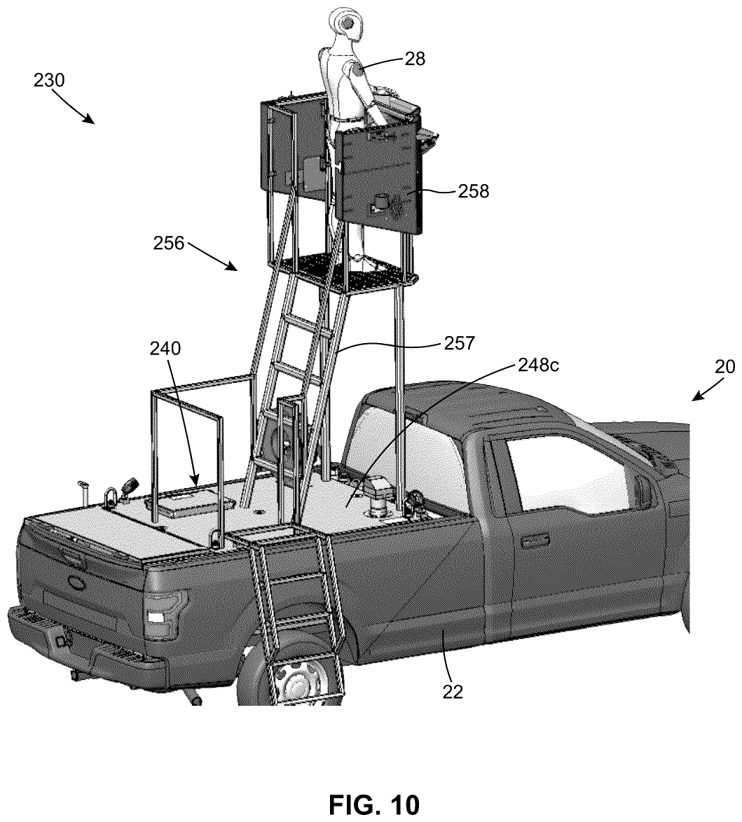

It is appreciated that a use of a non-dedicated vehicle with the portable deicing apparatus 30, 130, 230, such as a pickup truck, instead of a specialized and dedicated vehicle provides flexibility to a deicing operation. For instance, with the portable deicing apparatus 30, 130, 230 installed and secured to the bed of a service pickup truck, an operator 28 (FIG. 10) may coordinate the deicing of the components of the aircraft in quick succession with larger dedicated deicing machines. As an alternative combined use of the portable deicing apparatus, an operator 28 of the portable deicing apparatus 30, 130, 230 can apply deicing fluid on one side of the aircraft (e.g., one wing) while deicing fluid is being applied on another side thereof (e.g., the other wing) by a dedicated deicing vehicle or another portable deicing apparatus 30, 130, 230. As such, the portable deicing apparatus 30, 130, 230 may provide flexibility to a deicing operation of an airplane.

According to one implementation, components of the portable deicing apparatus 30, 130, 230 such as the deicing fluid reservoir 40, the component housing 50, and the energy supply assembly 80 (and all components associated therewith as described herein) are displaceable as a single assembly. In other words, the described components of the portable deicing apparatus 30, 130, 230 can be directly or indirectly structurally interconnected to form a substantially monolithic assembly (i.e., single unit) to facilitate transport and installation with the carrier assembly 22 and to ease its transition in and out of the carrier assembly 22.

Referring now to the embodiment shown in FIGS. 1 to 6, there is shown that the portable deicing apparatus 30 is displaceable as a single unit and includes the deicing fluid reservoir 40, the component housing 50, and a carburant reservoir 82 (which is part of the energy supply assembly 80) assembled together. In the non-limitative embodiment shown, the component housing 50 is located on a first side of the deicing fluid reservoir 40 and the carburant reservoir 82 is located on an opposite side of the deicing fluid reservoir 40. As it will be described in more details below, the first side can be referred to as the rear side to facilitate access to the component housing 50 when mounted to a carrier assembly 22 and the second side, as the front side. It is appreciated that the relative configuration of the deicing fluid reservoir 40, the component housing 50, and the carburant reservoir 82 can vary from the implementation shown. For instance, according to a non-illustrated implementation, the component housing 50 can be located on a lateral side of the deicing fluid reservoir 40.

The deicing fluid reservoir 40 defines a deicing fluid containing chamber (hereinafter also referred to as the “deicing fluid chamber”) (not shown) to contain the deicing fluid to be sprayed or otherwise applied outwardly. To provide non-limitative examples, the deicing fluid chamber can have a total capacity of between about 100 liters and about 1000 liters. In the non-limitative embodiment shown, the deicing fluid reservoir 40 is at least partially made of aluminum and/or steel. In one implementation, walls of the deicing fluid reservoir 40 can be lined with an insulation material, either inwardly or outwardly thereof. Non-limiting examples of insulation materials include spray foam and closed-cell foam.

According to an implementation, the deicing fluid reservoir 40 can be a double-walled reservoir. In one implementation, the double-walled reservoir includes an inner wall (not shown) and an outer wall, with the inner wall being made impervious to deicing fluid and at least partially delimiting the deicing fluid containing chamber, and the outer wall being spaced apart from the inner wall and adapted to at least provide protection to the inner wall and/or provide structural support to elements of the portable deicing apparatus 30 connected thereto. The inner wall can be covered or lined with insulation material on an outer surface thereof such that insulation material is interposed between the inner wall and the outer wall of the doubled-walled reservoir.

The component housing 50 is mounted to the deicing fluid reservoir 40. With reference to the non-limitative implementation shown in FIGS. 1 to 6, the component housing 50 is a rectangular-shaped container secured to a rear wall (not visible) on the first side of the deicing fluid reservoir 40. The component housing 50 is adapted to house, shelter and partially interconnect various components of the portable deicing apparatus 30 as will be described in more details below. Moreover, in the implementation shown, the component housing 50 comprises a housing access panel 54, pivotally mounted to a top plate of a front wall of the component housing 50. In FIGS. 1 to 5, the housing access panel 54 is configured in an open configuration to expose and provide vertical access to the components contained in the component housing 50. In a closed configuration (FIG. 7), the housing access panel 54 extends above the components contained in the component housing 50 and thus defines a top wall of the component housing 50. Alternatively, the component housing 50 access panel 54 can be pivotally mounted to a top plate of the rear wall of the deicing fluid reservoir 40 (not shown).

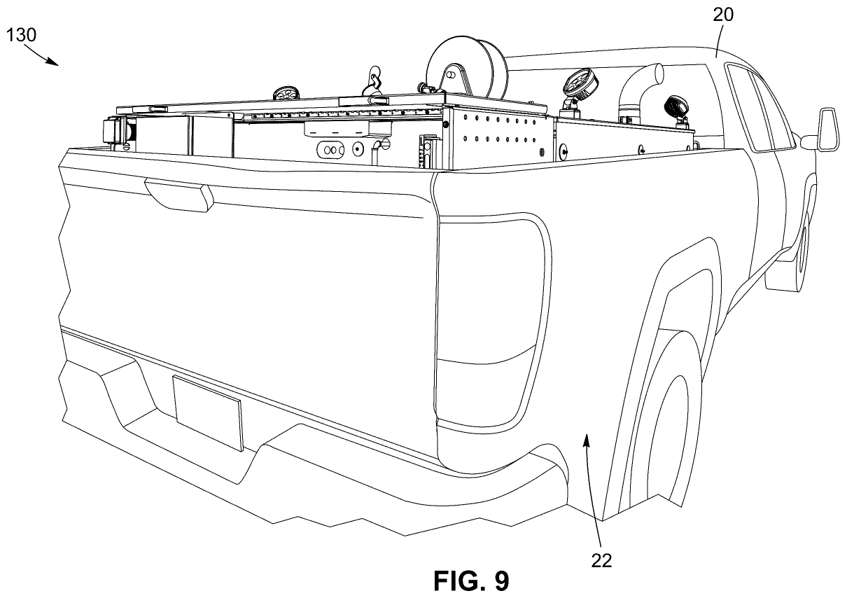

In the non-limitative embodiment shown in FIGS. 1 to 6, the component housing 50 of the portable deicing apparatus 30 is free of a rear wall. It is understood that in an implementation where the portable deicing apparatus 30 is installed with the carrier assembly 22 embodied by a bed of a pickup truck including a liftgate, the liftgate at least partially covers a rear side of the component housing 50 (FIGS. 9 and 10) thus further sheltering the components contained therein which dispenses with the need for a rear wall of the component housing 50.

The portable deicing apparatus 30 includes the heating system 70 to heat the deicing fluid, optionally before it is applied to components of the aircraft. As previously mentioned, deicing fluid, and more particularly Type I deicing fluid, is generally heated to a desired temperature before being applied for an optimal deicing effect. For this purpose, the heating system 70 is configured to heat the deicing fluid contained in the deicing fluid chamber to a desired “operating temperature”. As a non-limitative example, the operating temperature is about 160 degrees Fahrenheit for Type I deicing fluid. It is understood that the heating system 70 can be configured to maintain an operating temperature greater or smaller than 160 degrees Fahrenheit, as needed.

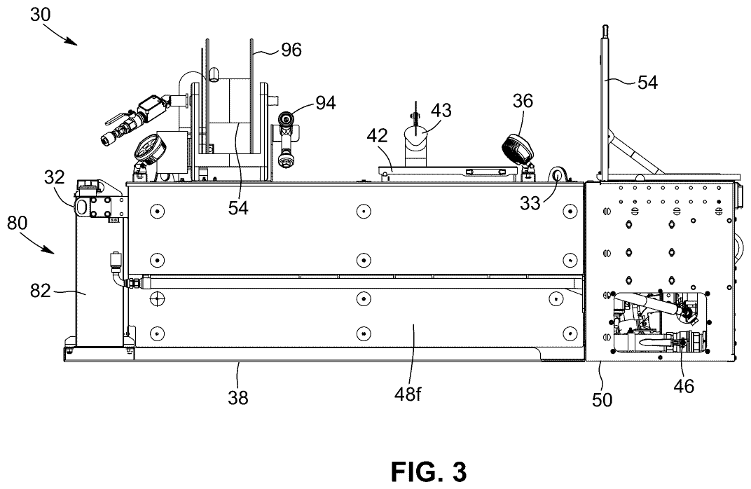

To heat the deicing fluid contained in the deicing fluid chamber of the deicing fluid reservoir 40, the portable deicing apparatus 30 includes the energy supply assembly 80 to provide the necessary energy to the heating system 70. In the non-limitative embodiment shown in FIGS. 1 to 6, the energy supply assembly 80 includes the carburant reservoir 82 containing a carburant as the energy supply for the heating system. The carburant reservoir 82 defines a carburant containing chamber (not shown) configured to contain the carburant (such as and without being limited to diesel) therein. The carburant containing chamber is in fluid communication with the heating system 70 and, more particularly, with a carburant burner 74, which will be described in more details below. As better shown in FIG. 3, the carburant reservoir 82 is fluidly connected to the heating system 70 located on the other side of the reservoir 40 partially in the component housing 50 via a pipe extending along the lateral side 48e of the deicing fluid reservoir 40.

In the embodiment shown, the heating system 70 includes a heating unit (not shown) in a heat exchange relationship with the deicing fluid contained in the deicing fluid reservoir 40 to provide heat thereto. In the non-limitative embodiment shown, the heating unit includes a heat exchanger (not shown) extending at least partially inside the deicing fluid containing chamber. The heat exchanger is configured to exchange heat between the carburant burner 74 and the deicing fluid contained in the deicing fluid chamber. For instance, and without being limitative, the heat exchanger can be embodied by a serpentine heat exchanger (not shown) which is at least partially confined in the deicing fluid chamber. To ensure that the deicing fluid remains in contact with serpentine heat exchanger when a level of deicing fluid within the deicing fluid chamber becomes low, a serpentine tube portion of the heat exchanger disposed within the deicing fluid chamber is located in a lower portion of the deicing fluid chamber, for instance adjacently and along a lower surface 48d of the deicing fluid reservoir 40.

The carburant burner 74 of the heating system 70 is fed with carburant from the carburant reservoir 82, which is part of the energy supply assembly 80, for combustion and heat production by the heat exchanger. In the embodiment shown, the carburant burner 74 is at least partially contained in the component housing 50. In the non-limitative implementation shown, the carburant burner 74 includes a diesel burner. The heating system 70 can include an exhaust pipe 78 to evacuate exhaust gases resulting from the carburant combustion process by the diesel burner. The exhaust pipe 78 is in fluid communication with a combustion chamber of the heating system 70. In the implementation including the serpentine heat exchanger which includes the combustion chamber fluidly connected to the serpentine tube portion, the exhaust pipe 78 is fluidly connected to an outlet of the serpentine tube portion about a front side of the deicing fluid reservoir 40. In an alternative implementation, the exhaust pipe 78 is in fluid communication with an outlet of the combustion chamber to evacuate gases resulting from the combustion of carburant.

In an alternative implementation, the energy supply assembly 80 can comprise one or more batteries operatively connected to the heating system 70 and, more particularly, the heat exchanger, such that the deicing fluid in the deicing fluid chamber can be heated through electric resistance of an electric heater resistor, for instance.

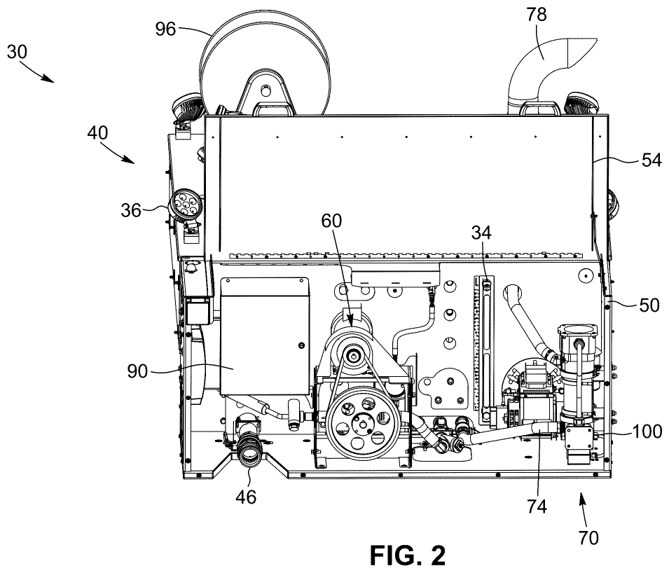

In the non-limitative embodiment shown, the heating system 70 also includes an external recirculation system 100 in fluid communication with the deicing fluid chamber of the deicing fluid reservoir 40. The external recirculation system 100 provides an auxiliary means for heating the deicing fluid that can be operated independently from the heating unit. The external recirculation system 100 can include fluid conduits in fluid communication with the deicing fluid chamber to define a closed circulation loop of the deicing fluid, a power supply connector (not shown) electrically connectable to an external power source (not shown), heat resistors and a fluid circulation device, such as pump. As better shown in FIG. 2, the external recirculation system 100 is at least partially contained inside the component housing 50. Therefore, when the external recirculation system 100 is actuated, the deicing fluid is continuously circulated, via the fluid circulation device, between the deicing fluid chamber and the fluid conduits to be heated therein by the heat resistors electrically supplied by the external power source. The external power source can be detachably connected to the power supply connector to provide energy for heating the deicing fluid and operating the fluid circulation device. For instance, and without being limitative, the external power source is a 240V power supply.

One intended and non-limited use of the external recirculation system 100 is to heat the deicing fluid contained in the deicing fluid reservoir 40 while the portable deicing apparatus 30 is not being deployed for a deicing operation. As a non-limitative example, after a day of operation, the portable deicing apparatus 30 can be stored indoors until the next day. In the meantime, the external recirculation system 100 of the otherwise idle deicing apparatus 30 can be electrically connected to the external power source to both heat and recirculate the deicing fluid throughout the night. The following day, the deicing fluid in the deicing fluid reservoir 40 is already at operating temperature or at least partially heated, such that the portable deicing apparatus 30 requires reduced energetic input from the other elements of the heating system 70, such as the heating unit. Advantageously, if the heating unit is implemented with the inclusion of a carburant burner 74, carburant is consequently saved. As such, carburant can be reserved for merely maintaining the deicing fluid contained in the deicing fluid reservoir 40 at operating temperature during outdoors operations of the portable deicing apparatus 30.

As better shown in the exemplary illustrations of FIGS. 1 to 5, the portable deicing apparatus 30 includes the fluid dispensing device 60 contained in the component housing 50. In the non-limitative embodiment shown, the fluid dispensing device 60 is a dispensing pump. The dispensing pump 60 is in fluid communication with one outlet of the deicing fluid chamber of the deicing fluid reservoir 40. The dispensing pump 60 is configured to withdraw deicing fluid from the deicing fluid reservoir 40 and propel the withdrawn deicing fluid outwardly, e.g. towards components of the aircraft at a suitable flow rate. Particularly, the dispensing pump 60 propels the pressurized deicing fluid to at least partially remove snow and ice from components of the aircraft. To this end, and to provide non-limitative examples, the dispensing pump 60 can have a capacity between about gallons per minute and about 15 gallons per minute. Still as a non-limitative example, the dispensing pump 60 can provide between about 50 PSI of pressure and about 200 PSI of pressure.

The dispensing pump can be actuated via a carburant-fed motor (FIGS. 7-9) or an electric motor (FIGS. 1-6). In the non-limitative embodiment shown in FIGS. 1 to 6, the dispensing pump 60 may include an electric motor. For example, the electric dispensing pump 60 can be embodied by a 12V, 1 HP electric pump. In such embodiment, the portable deicing apparatus 30 can include a battery (not shown in FIGS. 1 to 6) operatively connected to the dispensing pump 60 to provide energy thereto. The battery connected to the electric motor of the dispensing pump 60 can be contained in the component housing 50.

In a non-limitative implementation, the battery connected to the electric motor can be embodied by a deep cycle battery, itself operatively connected to the internal battery of the ground transport vehicle 20 when the portable deicing apparatus 30 is secured to the carrier assembly 22 (FIGS. 8 to 10). In a non-limitative example, the battery is connectable to a 4-pole flat connector provided in some ground vehicles and generally connected to the internal battery of the transport vehicle 20 capable of supplying up to 12V. In addition to the connection to the internal battery of the ground transport vehicle 20, the battery may also be connectable to an external power source, such as a 120V appliance power source, or an external 12V power source, to supplement or substitute the internal battery of the ground transport vehicle 20, if needed.

It should be noted that the battery can supply energy to other components of the portable deicing apparatus 30, which require electric current, as will be made apparent below.

The portable deicing apparatus 30 includes a discharge line (not shown) in fluid communication with the dispensing pump 60 to propel and direct deicing fluid suctioned (i.e., withdrawn) from the deicing fluid chamber outwardly, and in an embodiment, towards the components of an aircraft. Also, and as explained in more details below, the deicing fluid discharge line can be used to return a remaining portion of the deicing fluid in the discharge line back into the deicing fluid chamber. An intended and non-limitative use of the discharge line is to increase the effective range of the portable deicing apparatus 30 and assist in applying deicing fluid at a greater distance therefrom as the operator steps away from the deicing apparatus 30 or assumes an elevated position in relation to the deicing fluid reservoir 40, as explained further below (FIG. 10). In a non-limitative embodiment, the discharge line can be embodied by a 50-foot-long line. Alternatively, the discharge line can be between about 50 feet and about 100 feet long. Different lengths of the discharge line are contemplated herein.

To better control the application of deicing fluid, a free end of the discharge line can be equipped with a nozzle 94. As better shown in FIGS. 1, 3-5 and 7, the nozzle 94 can be a Strahman nozzle. However, any other type of nozzles appropriate for applying deicing fluid is contemplated herein.

In one implementation, the portable deicing apparatus 30 can include a reel 96. In the non-limitative embodiment shown in FIGS. 1 to 4, the reel 96 is mounted to an upper surface 48c of the deicing fluid reservoir 40. The discharge line can be coiled around the reel 96 provided to ease storage and transportation. According to another implementation, the reel 96 can be equipped with a spring (not shown) configured to load when the discharge line is extended away from the deicing fluid reservoir 40 and correspondingly uncoils from the reel 96. The loaded spring then assists in retracting the discharge line towards and around the reel 96 when the discharge line is released. Alternatively, the reel 96 can be equipped with an actuator, such as an electric motor, actionable to rotate the reel 96 and coil or uncoil the discharge line thereon or therefrom automatically.

Referring to FIGS. 1-3 and 6-8, the deicing fluid reservoir 40 includes a deicing fluid outlet 46 in fluid communication with the deicing fluid chamber. According to one implementation, the deicing fluid outlet 46 protrudes from the front side of the deicing fluid reservoir 40 and is at least partially contained in the component housing 50. It should be noted that according to a non-limitative use, the deicing fluid outlet 46 can be used to drain the deicing fluid from the deicing fluid chamber. It should be noted that although the expression “outlet” is being used herein in relation to the deicing fluid outlet 46, in some implementations, the deicing outlet is not limited to draining deicing fluid and may be used as an inlet to fill the deicing fluid chamber with deicing fluid with appropriate external means. In one implementation better illustrated in FIGS. 1-3 and 7, the deicing fluid outlet 46 can be positioned proximate the lower surface 48d of the deicing fluid reservoir 40 so that the deicing fluid can be gravity-drained. As better shown in the implementation of FIG. 8, the deicing fluid outlet 46 can be embodied by a ball valve equipped with a protective cap (not shown).

The deicing fluid reservoir 40 can also include a deicing fluid inlet 42 to fill the deicing fluid chamber with deicing fluid. In the non-limitative implementation of FIGS. 1 to 6, the deicing fluid inlet 42 is at least partially defined on the upper surface 48c of the deicing fluid reservoir 40. In the implementation shown, the deicing fluid inlet 42 can be provided with an access hatch, shown in a closed configuration, to cover the deicing fluid inlet 42, and removable to uncover the fluid inlet 42, to selectively introduce deicing fluid into the deicing fluid chamber from the outlet of the discharge line, for instance.

According to one implementation shown in FIGS. 1 to 5, the portable deicing apparatus 30 can also include a safety valve 43 in fluid communication with the deicing fluid chamber of the deicing fluid reservoir 40. In the implementation shown, the safety valve 43 includes an outwardly-extending overflow duct protruding from the access hatch (which covers the fluid inlet 42) and a covering flap pivotally mounted to an upper end portion of the duct (shown in a closed configuration). It should be noted that the safety valve 43 can be located anywhere on the upper surface 48c of the deicing fluid reservoir 40. In the event that the deicing fluid chamber is filled beyond its holding capacity, the excess deicing fluid would rise therein to reach the upper surface 48c of the deicing fluid reservoir 40 and would then overflow through and out of the safety valve 43, thus avoiding an excessive build-up of pressure within the deicing fluid chamber.

One intended and non-limited use of the deicing fluid inlet 42 and/or the safety valve 43 is to combine with the discharge line to recover cold or below operating temperature deicing fluid lingering in the discharge line. For context, at the beginning of a deicing operation, the discharge line may hold deicing fluid from a previous deicing operation that has been withdrawn from the deicing fluid chamber without having been ejected from the discharge line (i.e., the remaining portion). Thus, the fluid dispensing device 60 can be used to expel unheated deicing fluid lingering in the discharge line directly into the deicing fluid chamber through the deicing fluid inlet 42 and optionally the safety valve 43. More specifically, in one implementation, the access hatch covering the fluid inlet 42 can be opened and the nozzle 94 equipped with the discharge line can be inserted in the deicing fluid inlet 42 to propel deicing fluid into the deicing fluid chamber until all the fluid inside the discharge line is fully replaced with deicing fluid heated at operating temperature by the heating system 70. Alternatively, the covering flap of the safety valve 43 can be configured into an open configuration and the nozzle 94 of the discharge line can be inserted in the deicing fluid inlet 42 to propel deicing fluid into the deicing fluid chamber. In other words, the combination of the discharge line and the fluid inlet 42 as described herein selectively creates a closed recirculation loop for reducing potential waste of accumulated deicing fluid below its operating temperature that would otherwise be discarded or ineffectively sprayed on an aircraft component at the beginning of the deicing operation.

The portable deicing apparatus 30 includes the controller 90, contained inside a panel box as a protective measure, at least partially contained inside the component housing 50 and operatively connected to at least the fluid dispensing device 60, such as the dispensing pump, and the heating system 70. In one implementation, the controller 90 is powered by the battery. In some implementations, the controller can include a manual emergency kill switch so that an operator may switch off all deicing apparatus components that are operatively connected to the controller when desired.

The portable deicing apparatus 30 can include sensors configured to safeguard against deicing fluid overheating, overfilling and/or a scarceness in the deicing fluid chamber, for instance, as explained in below. The sensor configuration described herein can be implemented in addition or as an alternative to other safety measures, such as and without being limited to, the safety valve 43, for instance.

For example, the deicing fluid chamber can include at least one temperature sensor (not shown). According to one implementation, a temperature sensor is provided and configured to detect a temperature of the deicing fluid above an upper temperature threshold (e.g., 200 degrees Fahrenheit). The temperature sensor can be operatively connected to the controller 90 which is adapted to automatically switch off the heating system 70 and the dispensing device 60 upon detection of the upper temperature threshold. Additionally or alternatively, the temperature sensor can be operatively connected to signaling means to warn an operator when the upper temperature threshold is reached.

According to another implementation involving sensors, the portable deicing apparatus 30 can include at least one flowmeter (i.e., at least one flow sensor) configured to detect and measure a liquid flow of the deicing fluid being propelled from the dispensing device 60. In one implementation, the panel box is operatively connected to display means to inform an operator of the measurement by the flowmeter.

According to another implementation involving sensors, the deicing fluid chamber includes at least two fluid level sensors (not shown). A fluid level sensor is positioned in a lower portion of the deicing fluid chamber and configured to detect when a volume of deicing fluid is below a lower fluid threshold. The fluid level sensor can be operatively connected to the controller 90 which is configured to automatically switch off the dispensing device 60 and the heating system 70 upon detection of the lower fluid threshold. It is appreciated that running a fluid dispensing device 60 or pump without fluid (i.e., “dry running”) may damage the fluid dispensing device 60. It is also understood that operating the heating system 70 without deicing fluid may lead to overheating of the portable deicing apparatus 30. Additionally or alternatively, the deicing fluid reservoir 40 can include a fluid level gauge 34 (better shown in FIG. 2) to provide a visual indication of the fluid level within the deicing fluid chamber.

It is understood that the portable deicing apparatus 30 may be operated at night or in poor visibility conditions. According to the implementation illustrated in FIGS. 1 to 9, the portable deicing apparatus 30 includes lights 36, which are in the non-limitative embodiment shown mounted on the upper surface 48c of the deicing fluid reservoir 40. The lights 36 can be operatively connected to the battery, and to the controller 90 to be selectively switched on and off.

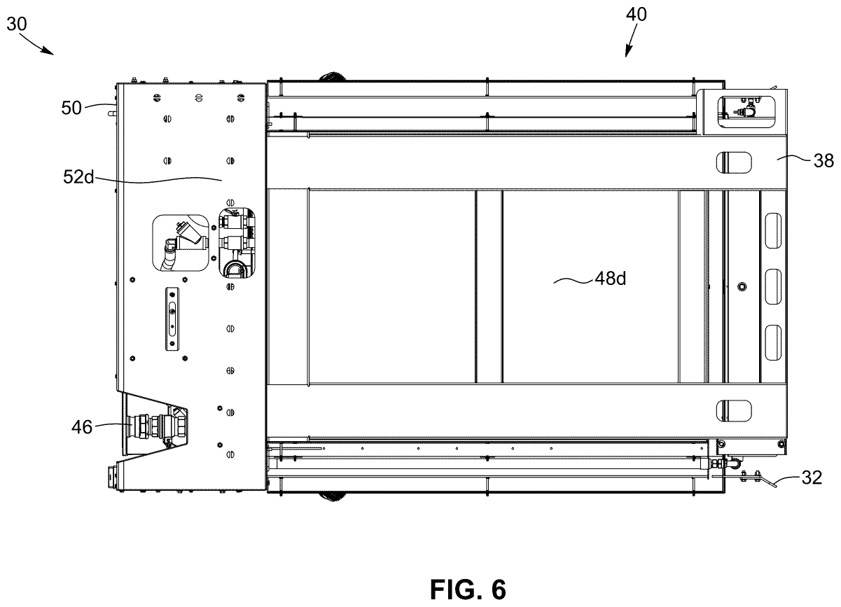

Referring now to FIG. 6, there is shown that each one of the deicing fluid reservoir 40 and the component housing 50 has a lower surface and that each lower surface 48d, 52d is substantially planar. The planar configuration of the lower surfaces 48d, 52d enables for at least one to contact a supporting surface 26 of the carrier assembly 22. For example, the supporting surface 26 of the carrier assembly 22, such as the one shown in FIG. 8, is embodied by a floor panel of the bed of the pickup truck 20. The planar lower surfaces 48d, 52d enable the portable deicing apparatus 30 to be uniformly supported by the supporting surface 26. A lower planar surface also provides flexibility insofar that the portable deicing apparatus 30 can be secured to any carrier assembly 22 compatible with a planar configuration, provided that other dimensions are consistent.

Referring to the non-limitative implementation illustrated in FIG. 6, to at least partially provide structural support to its components, the portable deicing apparatus 30 includes a base frame 38 engaged with at least the deicing fluid reservoir 40. According to one implementation, the base frame 38 extends beneath the lower surface 48d of the deicing fluid reservoir 40 and a lower surface (not visible) of the carburant reservoir 82. In such implementation, the base frame 38 can be sized and shaped not only to support other components of the portable deicing apparatus 30 but also to engage the supporting surface 26 of the carrier assembly 22 according to a planar configuration thereof. In the implementation shown, a lower surface of the base frame 38 and the lower surface 52d of the component housing 50 complementarily form a contiguous planar surface. In an alternative non-illustrated embodiment, the base frame 38 extends further longitudinally in a rearward direction such as to support the component housing 50 instead or in addition to the lower surface 52d thereof.

To enable a secured engagement of the portable deicing apparatus 30 with the carrier assembly 22, the apparatus can include mechanical fasteners 32 mounted to at least one of the deicing fluid reservoir 40 and the component housing 50. As better shown in the implementations of FIGS. 1, 3, 4 and 7, the mechanical fasteners 32 can be fixed to the surfaces of the deicing fluid reservoir 40. In the non-limitative implementation shown in FIGS. 1 to 5, the portable deicing apparatus 30 is further equipped with lift hooks 33 onto which a crane for instance, can attach to subsequently lift and displace the apparatus 30 as needed. In the illustrative embodiment of FIGS. 1 to 5, four lift hooks 33 are disposed on the upper surface 48c of the deicing fluid reservoir 40 proximate corners thereof. Another non-limited means of displacing the portable deicing apparatus 30 involves the use of a forklift. For instance, in one implementation, the forks of a forklift can be inserted in between the supporting surface 26 of the carrier assembly 22 and the supporting component housing 50 and base frame 38 of the portable deicing apparatus 30 and raised therefrom to be displaced as needed. Other displacement means are also contemplated by this disclosure.

Referring now to FIGS. 7 to 10, there is shown an alternative embodiment of the portable deicing apparatus 130 wherein the features are numbered with reference numerals in the 100 series which correspond to the reference numerals of the previous embodiment. The portable deicing apparatus 130 is similar to the one shown in FIGS. 1 to 6, except that it is exempt of the external recirculation system 100. The portable deicing apparatus 130 shown also foregoes the electric motor and instead includes a carburant motor operatively connected to the dispensing pump 160 and may include a pump carburant reservoir 164 to contain and supply carburant to the dispensing pump 160. For example, the carburant motor can be embodied by a roller pump, further operatively connected to a battery 138 to turn over the roller pump.

Referring now to FIG. 10, there is shown an alternative embodiment of the portable deicing apparatus 230 wherein the features are numbered with reference numerals in the 200 series which correspond to the reference numerals of the previous embodiment. The portable deicing apparatus 230 is similar to the one shown in FIGS. 1 to 6, except that the portable deicing apparatus 230 includes an elongated frame 256 mounted to an upper surface 248c of the deicing fluid reservoir 240 and extending upwardly therefrom. In the implementation shown, the elongated frame 256 includes a ladder 257 (i.e. the main ladder) and a basket 258 (i.e. a platform) positioned at an upper end of the main ladder 257.

A contemplated and non-limitative use of the implementation of the portable deicing apparatus 230 having the elongated frame 256 with the basket 258 as described herein is to widen the range of items that the portable deicing apparatus 230 can service. As partially illustrated in the implementation of FIG. 10, an operator 28 may climb into the basket 258 with access to the nozzle 94 of the discharge line (not represented) to dispense deicing fluid from a high vantage point enabled by the elongated frame 256. In one non-limitative implementation, the elongated frame 256 has a height of between about 120 inches to about 150 inches (not including the additional height provided by the carrier assembly 22) which can be high enough to apply a jet of deicing fluid on the upper surfaces of relatively small aircraft.

According to a method, the implementations of the portable deicing apparatus 30, 130, 230 as described herein can be transferred from a first carrier assembly to a second carrier assembly. In one implementation, and as a first step, the portable deicing apparatus 30, 130, 230 is detached from the first carrier assembly. For instance, if the deicing apparatus includes mechanical fasteners 32 as previously described, this step provides detaching the mechanical fasteners 32 from the first carrier assembly. Then, as a second step, the portable deicing apparatus 30, 130, 230 is displaced to the second carrier assembly as a single assembly (i.e. as a single unit) with the displacing means described herein (e.g., by forklift or crane). Finally, as a third step, the portable deicing apparatus 30, 130, 230 can be detachably secured to said second carrier assembly, with the means described herein.

According to a method for preliminarily warming the deicing fluid carried by a portable deicing apparatus 30 in view of the deicing operation. The method comprises providing the portable deicing apparatus 30 having the deicing fluid reservoir 40 defining the deicing fluid containing chamber carrying deicing fluid. The heating system 70 includes the external recirculation system 100 in fluid communication with the deicing fluid containing chamber and the power supply connector electrically connectable to an external power source. Then, preliminarily to the deicing operation wherein deicing fluid is sprayed outwardly of the portable deicing apparatus 30, the power supply connector of the external recirculation system 100 is connected to the external power source to continuously recirculate the deicing fluid between the deicing fluid containing chamber and the recirculation system in a closed circulation loop to provide a heat exchange therebetween and warm the deicing fluid to the desired operating temperature. Finally, the method comprises disconnecting the power supply connector of the external recirculation system 100 from the external power source before the deicing operation. In one implementation, the method for preliminarily warming the deicing fluid further includes displacing the portable deicing apparatus 30 containing the warm deicing fluid to the corresponding carrier assembly 22 of the ground transport vehicle 20 as a single assembly and detachably securing the portable deicing apparatus 30 to same. Inversely, the method can further include unloading the portable deicing 30 off the carrier assembly 22 before connecting the power supply connector to the external power source.

The dimensions of the portable deicing apparatus 30, 130, 230 illustrated in the implementations of FIGS. 1 to 10 are between about 90 inches to about 100 inches in length, between about 50 inches to about 60 inches in width, and between about 40 inches to about 50 inches in height (excluding the height of the elongated frame 256, as seen in the implementation of the deicing apparatus 230 of FIG. 10). Different dimensions of the portable deicing apparatus 30, 130, 230 are contemplated herein, depending on the specifications of the carrier assembly 22, for instance.

In the previous description, non-limitative implementations of the method are described. Although these embodiments of the assembly and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the method, as will be briefly explained herein and as can be easily inferred herefrom by a person skilled in the art. Moreover, it will be appreciated that positional descriptions such as “above”, “below”, “left”, “right”, “bottom”, “top”, “end” and the like should, unless otherwise indicated, be taken in the context of the figures and should not be considered limiting.

Furthermore, in the previous description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The implementations, geometrical configurations, materials mentioned and/or dimensions shown in the figures are optional and are given for exemplification purposes only.

In the following description, an embodiment is an example or implementation. The various appearances of “one implementation”, “an implementation” or “some implementations” do not necessarily all refer to the same implementation or embodiment. Although various features may be described in the context of a single implementation, the features may also be provided separately or in any suitable combination. Conversely, although the invention may be described herein in the context of separate implementations for clarity, it may also be implemented in a single embodiment. Reference in the specification to “some implementations”, “an implementation”, “one implementation” or “other implementations” means that a particular feature, structure, or characteristic described in connection with the implementations is included in at least some implementations, but not necessarily all implementations.

It is to be understood that the phraseology and terminology employed herein are not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

It will be appreciated that the methods described herein may be performed in the described order, or in any suitable order.

Several alternative embodiments, implementations and examples have been described and illustrated herein. The embodiments of the invention described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind.

1. A portable deicing apparatus for spraying deicing fluid, the portable deicing apparatus comprising:
a deicing fluid reservoir defining a deicing fluid containing chamber and having an upper surface;
a component housing connected to the deicing fluid reservoir;
a fluid dispensing device at least partially located inside the component housing and in fluid communication with the deicing fluid containing chamber to propel deicing fluid contained in the deicing fluid containing chamber outwardly;
a heating system having a heating unit in a heat exchange relationship with the deicing fluid contained in the deicing fluid containing chamber;
an energy supply assembly operatively connected to the heating unit; and
a controller at least partially located inside the component housing and operatively connected to at least the fluid dispensing device and the heating system; and
wherein the deicing fluid reservoir, the component housing, the fluid dispensing device, the heating system, the energy supply assembly, and the controller are displaceable as a single assembly.

2. The portable deicing apparatus as claimed in claim 1, further comprising mechanical fasteners mounted to at least one of the deicing fluid reservoir and the component housing to detachably secure the portable deicing apparatus as the single assembly of a ground transport vehicle.

3. The portable deicing apparatus as claimed in claim 2, wherein the mechanical fasteners are mounted to the deicing fluid reservoir and wherein the mechanical fasteners include hooks provided on lateral surfaces of the deicing fluid reservoir.

4. The portable deicing apparatus as claimed in claim 2, wherein the portable deicing apparatus further comprises a battery operatively connectable to an internal battery of the ground transport vehicle.

5. The portable deicing apparatus as claimed in claim 4, wherein the fluid dispensing device comprises an electric pump operatively connected to the battery configured to supply energy to the electric pump.

6. The portable deicing apparatus as claimed in claim 1, wherein the portable deicing apparatus further comprises a safety valve in fluid communication with the deicing fluid containing chamber, the safety valve including an overflow duct extending outwardly from the upper surface of the deicing fluid reservoir and a covering flap pivotally mounted to an upper end portion of the overflow duct.

7. The portable deicing apparatus as claimed in claim 1, wherein the deicing fluid reservoir further comprises a deicing fluid outlet and a deicing fluid inlet providing access to the deicing fluid containing chamber, and the portable deicing apparatus further comprising a deicing fluid discharge line in fluid communication with the fluid dispensing device to propel and apply deicing fluid contained in the deicing fluid containing chamber, and wherein the deicing fluid discharge line is engageable with the deicing fluid inlet to collect and return a remaining portion of the deicing fluid into the deicing fluid containing chamber.

8. The portable deicing apparatus as claimed in claim 1, wherein the heating unit comprises a heat exchanger extending at least partially inside the deicing fluid containing chamber.

9. The portable deicing apparatus as claimed in claim 8, wherein the heating system comprises a carburant burner in the heat exchange relationship with the heat exchanger and the energy supply assembly comprises a carburant reservoir mounted to at least one of the deicing fluid reservoir and the component housing, the carburant reservoir defining a carburant containing chamber in fluid communication with the carburant burner.

10. The portable deicing apparatus as claimed in claim 9, wherein the energy supply assembly comprises a battery operatively connected to the heat exchanger.

11. The portable deicing apparatus as claimed in claim 1, wherein the heating system further comprises an external recirculation system at least partially contained in the component housing and in fluid communication with the deicing fluid containing chamber, and a power supply connector electrically connectable to an external power source.

12. The portable deicing apparatus as claimed in claim 1, further comprising an elongated frame mounted to the upper surface of the deicing fluid reservoir and extending upwardly therefrom, the elongated frame comprising a ladder and a basket mounted to the ladder and located at an upper end thereof.

13. A portable deicing apparatus for spraying deicing fluid in combination with a ground transport vehicle having a carrier assembly, the portable deicing apparatus of claim 1;
wherein the carrier assembly of the ground transport vehicle comprises anchors engageable by the mechanical fasteners of the portable deicing apparatus to detachably secure the portable deicing apparatus to the carrier assembly.

14. The portable deicing apparatus as claimed in claim 13, wherein the portable deicing apparatus further comprises a base frame engaged with at least the deicing fluid reservoir, providing mechanical support thereto and having a planar lower surface, and wherein the carrier assembly has a supporting surface engageable with at least the planar lower surface of the base frame.

15. The combination as claimed in claim 14, wherein the component housing has a planar lower surface, and wherein the planar lower surface of the base frame and the planar lower surface of the component housing are arranged to form a contiguous planar surface engageable with the supporting surface of the carrier assembly.

16. The combination as claimed in claim 13, wherein the carrier assembly is one of a trailer having a bed and a pickup bed.

17. The combination as claimed in claim 13, wherein the carrier assembly has a supporting surface and wherein each one of the deicing fluid reservoir and the component housing have a lower surface and the lower surfaces are planar for at least one of the lower surface of the deicing fluid reservoir and the lower surface of the component housing to contact the supporting surface of the carrier assembly.

18. A method for transferring a portable deicing apparatus from a first carrier assembly to a second carrier assembly, the method comprising:
detaching the portable deicing apparatus from the first carrier assembly, the portable deicing apparatus comprising:
a deicing fluid reservoir defining a deicing fluid containing chamber; a fluid dispensing device in fluid communication with the deicing fluid containing chamber to propel deicing fluid contained in the deicing fluid containing chamber outwardly; a heating system having a heating unit in a heat exchange relationship with the deicing fluid contained in the deicing fluid reservoir; an energy supply assembly operatively connected to the heating unit; and a controller operatively connected to at least the fluid dispensing device and the heating system; and
displacing the portable deicing apparatus to the second carrier assembly as a single assembly; and
detachably securing the portable deicing apparatus to the second carrier assembly.

19. A method for preliminarily warming deicing fluid of a portable deicing apparatus for a deicing operation, the method comprising:
providing a portable deicing apparatus, comprising:
a deicing fluid reservoir defining a deicing fluid containing chamber containing deicing fluid, a heating system including an external recirculation system in fluid communication with the deicing fluid containing chamber, the external recirculation system having a power supply connector electrically connectable to an external power source; and
preliminarily to a deicing operation wherein deicing fluid is sprayed outwardly of the portable deicing apparatus, connecting the power supply connector of the external recirculation system to the external power source to continuously recirculate the deicing fluid between the deicing fluid containing chamber and the external recirculation system in a closed circulation loop to provide a heat exchange therebetween and warm the deicing fluid to an operating temperature; and
disconnecting the power supply connector of the external recirculation system from the external power source before the deicing operation.

20. The method of claim 19, further comprising displacing the portable deicing apparatus to a carrier assembly of a ground transport vehicle as a single assembly and detachably securing the portable deicing apparatus to same.
